(19) United States
(12) Patent Application Publication
(10) Pub. No.: US 2009/0004325 A1
(43) Pub. Date: Jan. 1, 2009

(54) Device for Filling an Extruder with Pretreated Thermoplastic Material

(75) Inventors: Helmut Bacher, St. Florian (AT); Helmuth Schulz, Linz (AT); Klaus Feichtinger, Linz (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: EREMA Engineering Recycling Maschinen Und Anlagen Gesellschaft M.B.H., Ansfelden (AT)

(21) Appl. No.: 11/883,148

(22) PCT Filed: Dec. 22, 2005
(86) PCT No.: PCT/AT2005/000521

§ 371 Date: May 16, 2008

(30) Foreign Application Priority Data
Jan. 28, 2005 (AT) A 142/2005

(51) Int. Cl. B29C 47/10

(52) U.S. Cl. 425/586; 425/587

(57) ABSTRACT

A device for filling an extruder, which can optionally be an external extruder, with pretreated thermoplastic plastics material, in particular PET, has at least one evacuatable container (1) in which moving, in particular rotating, tools (7) are provided for pretreatment of the material. This pretreatment comprises drying and, optionally, crystallisation. Each container (1) has a discharge opening (18) for the flowable material (12), which discharge opening (18), with respect to the material, is fluidically connected to the filling opening (35) of the extruder (36). The device preferably has only a single container stage, the outlet of which is fluidically connected to a coupling (69), which is connectable to the filling opening (35) of the extruder (36), via a transfer section (31) maintaining the flowable state of the material (12) pretreated in the container (1) (FIG. 1).

The invention relates to a device for filling an extruder with pretreated thermoplastic plastics material, in particular PET, comprising at least one evacuatable container in which moving, in particular rotating, tools are provided for pretreatment of the material, wherein the pretreatment comprises drying and, optionally, crystallisation or partial crystallisation of the material, and wherein each container has a discharge opening for the preferably at least partly crystallised material, which discharge opening, with respect to the material, is fluidically connected to the filling opening of the extruder.

A device of this type is known from AT 411235 B. This known device is very suitable for the recycling of thermoplastic plastics material, in particular PET (polyethylene terephthalate), which is mostly fed to the device in the form of comminuted bottle material, frequently in chip form. The recycled material produced by the device can be used in the food packaging industry. However, the known device has a certain apparatus and also energy requirement, and there is frequently the desire among customers to be able to use existing installation parts in a suitable manner in combination with the device. This frequently entails problems with respect to the connection of the filling device to the extruder.

The invention starts from a device of the initially described type and has the object of making the device more universally usable and more easily controllable and of keeping the energy requirement lower by reducing energy losses. Lastly, it should also be possible to reduce the apparatus requirement in comparison with the known device. The invention achieves this object in that a transfer section, which maintains the flowable state of the material pretreated in the containers, is connected to the outlet opening of the containers so as to form a sealed fluidic connection for the material, the containers optionally forming a plurality of container stages, and in that this transfer section has, at its outlet, a coupling which is directly connectable in a sealed manner to the filling opening of the extruder. A device of this type, according to the invention, still provides vacuum treatment of the material in the container, as in the initially described known device, but avoids the necessary multi-stage formation of the known device since the device according to the invention can also have a one-stage formation with only a single container, which will even be the case in the majority of cases. The fewer stages or containers there are, the more easily controllable the device becomes and the lower the energy losses become, in addition to the reduced apparatus requirement. The maintenance of the flowable state of the treated material as far as the extruder inlet is particularly important in the invention. The flowability of the material presupposes that the material in the containers or the container is dried and usually also at least partly crystallised and passes in this state to the common outlet of the containers, but is not plasticised and therefore not sticky. The aforementioned state of the material is therefore maintained in the entire region lying between the outlet of the containers and the extruder inlet and formed by the transfer section. Differently treated, namely plasticised material, is extremely sticky, which has a disadvantageous effect on uniform filling of the extruder. If this filling process takes place non-uniformly or even if there are more or less brief interruptions caused by agglutinations, e.g. due to poor or non-uniform crystallisation, this can lead to the feared “pumping” of the extruder, which, as experience has shown, leads to problems in the further processing installation connected to the extruder. However, if the device according to the invention ensures uniform filling of the extruder via the flowable state of the material fed to the extruder, then not only does this avoid the described difficulties, but a higher extruder throughput is usually also achieved.

The transfer section also facilitates structural adaptation to the filling opening of the extruder since the local conditions are frequently such that a sometimes considerable spatial distance has to be maintained between the container and the extruder. This distance can be bridged by the transfer section without any problems.

Measures for maintaining the flowable state of a plastics material are known per se. Thus it is sufficient here to mention briefly only some of the most important measures, e.g. the avoidance of an increase in the temperature of the material throughout the transfer section, or the avoidance of cross-sectional reductions in the transfer section or of compressing members, the maintenance of correct discharge angles of hoppers, etc.

Above all, however, the device according to the invention takes account of the fact that extruders frequently already exist in plastics processing operations, in particular in the recycling industry. Consequently, in the device according to the invention, the extruder does not necessarily form a component of the device, i.e. the extruder does not necessarily have to originate from the same manufacturer as the parts of the installation connected upstream of the extruder. Such extruders, which were already present at the site of the installation and by which the treated material is ultimately plasticised and supplied for further processing, will be referred to hereinbelow as “external extruders”. These are conventional extruders (single-screw, twin-screw or multi-screw extruders) which, however, are not immediately suitable for processing PET material to be recycled because the feedstock in conventional installations is usually moist or non-crystalline and, in this form, suffers during recycling treatment. For connection of the device according to the invention to these existing extruders, according to a further development of the invention the device itself is extruderless and is directly connectable in a sealed manner by means of the coupling to the filling opening of an extruder formed by an external extruder. Two basic variants arise here, according to whether the feed region of the filling opening of the external extruder is vacuum-tight or not. In the former case, the transfer section is evacuatable. This evacuation of the transfer section can be effected by the vacuum generated in the container. This vacuum takes effect in the vacuum-tight transfer section and also in the feed region of the extruder. If, on the other hand, the aforementioned feed region is not vacuum-tight and if this feed region also cannot be brought into a vacuum-tight state without unacceptable expenditure or if, with respect to the overall installation, the desire is to set different vacuums in the container and the transfer section, then the transfer section contains a vacuum sluice. The aforementioned vacuum-tightness of the extruder is to be understood to mean that the vacuum in the transfer section is not substantially disrupted by the extruder, with the result that there is no substantial deterioration of the flowable material passing through the transfer section because any ingress of atmospheric oxygen and/or atmospheric moisture is only small.

The feed region of the extruder is to be understood as that region which is adjacent to the filling opening of the extruder, in particular on the side of the extruder remote from the extruder head, which is usually the motor side.

The particular structural formation of the transfer section is dependent upon the characteristics of the intended field of application. The transfer section can have at least one hopper or hopper-like collecting chamber, into which the pretreated material coming from the container can flow. However, a delivery device can also be connected to the discharge opening of the container, e.g. a screw (which has to operate in a substantially compressionless manner so as not to impair the flowability of the material) or a cellular-wheel conveyor or the like. This provides the possibility, in a simple manner, of regulating the amount of material fed to the extruder inlet per unit time by providing a means for regulating the feed volume or feed weight of the delivery device. As an alternative to such a delivery device, a valve, in particular a slider, which regulates the discharge of the material from the container, can be provided between the discharge opening of the container and the transfer section within the scope of the invention.

As already mentioned, the extruder can also be a twin- or multi-screw extruder. In this case, it is advantageous to form the construction according to the invention so that the transfer section has a dosing means for filling such an extruder. Twin- or multi-screw extruders only plasticise well in the partly filled (underfed) state, which condition is fulfilled by the dosing means in a simple manner. Regulation of the feed volume or the feed weight can also take place in the dosing means.

The transfer section can also have at least one transfer chamber provided with a level control.

As already mentioned, the invention provides advantages in those cases in which there are difficult local conditions, e.g. no space in the vicinity of the extruder or other circumstances which necessitate a considerable spatial distance between the extruder and the device. In such cases, the transfer section can have at least one conveying means for the flowable material, e.g. a feed screw, which conveying means bridges at least a large part of the aforementioned distance.

As the aforementioned pretreated material is usually sensitive to atmospheric oxygen and/or atmospheric moisture, it should be attempted, if possible, to keep the entire transfer section sealed in relation to the ambient air and to keep it evacuatable. If this cannot be reliably achieved, the vacuum in the container can be secured by a vacuum sluice, which has already been mentioned and is located in the transfer section, and the unevacuatable region can be flushed with a gaseous medium, e.g. inert gas, dry air or hot air, which protects the material in this region. It is advantageous to arrange such a vacuum sluice in the transfer section in the vicinity of the filling opening of the extruder or in the vicinity of the coupling so as to be able to keep a large part of the transfer section under vacuum without any problems, e.g. by also allowing the vacuum generated in the container to be effective in this part of the transfer section.

Naturally, all these aforementioned variants can be used in any combination in accordance with the intended field of application.

In the simplest case, however, there is also the possibility of forming the transfer section as a channel which connects the outlet opening of the container directly to the coupling. The material treated in the container is flung into this channel by the rotating tools.

In all embodiments, the processed plastics material, in particular PET, is not melted or plasticised until it is in the extruder, which can be constructed with or without degassing.

Single-stage formation of the device according to the invention does not necessarily mean that only a single container is provided, although this configuration is usually provided. However, it is also possible for two or more containers to feed in parallel into a common outlet, optionally alternately, from which outlet the material is fed to the extruder in the manner described. Likewise, it is possible, albeit with increased expenditure, to provide two or more container stages, through which the treated material passes in turn. Each of these container stages can comprise one or more containers. Naturally, it also applies to all these embodiments that the flowable state of the processed material is always maintained as far as the filling opening of the extruder.

Embodiments of the device according to the invention are schematically shown in the drawing.

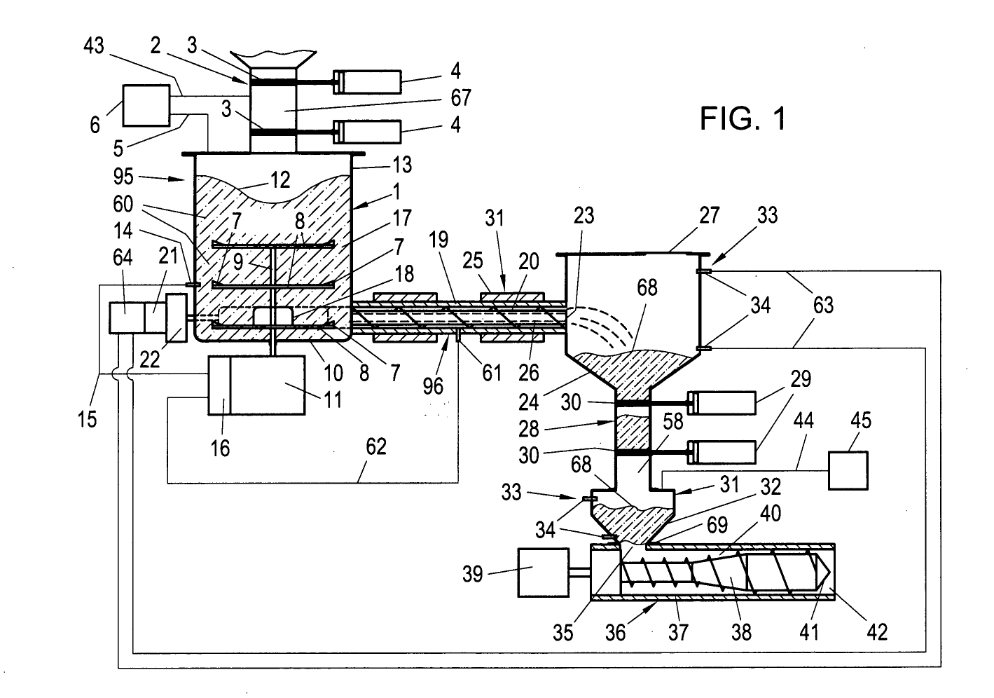

FIG. 1 shows an embodiment with a level-regulated transfer hopper.

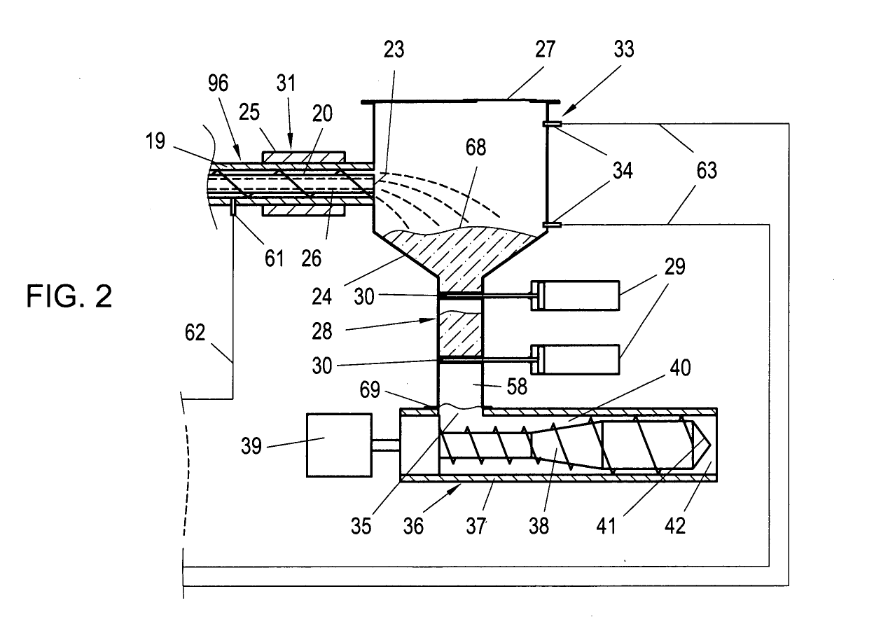

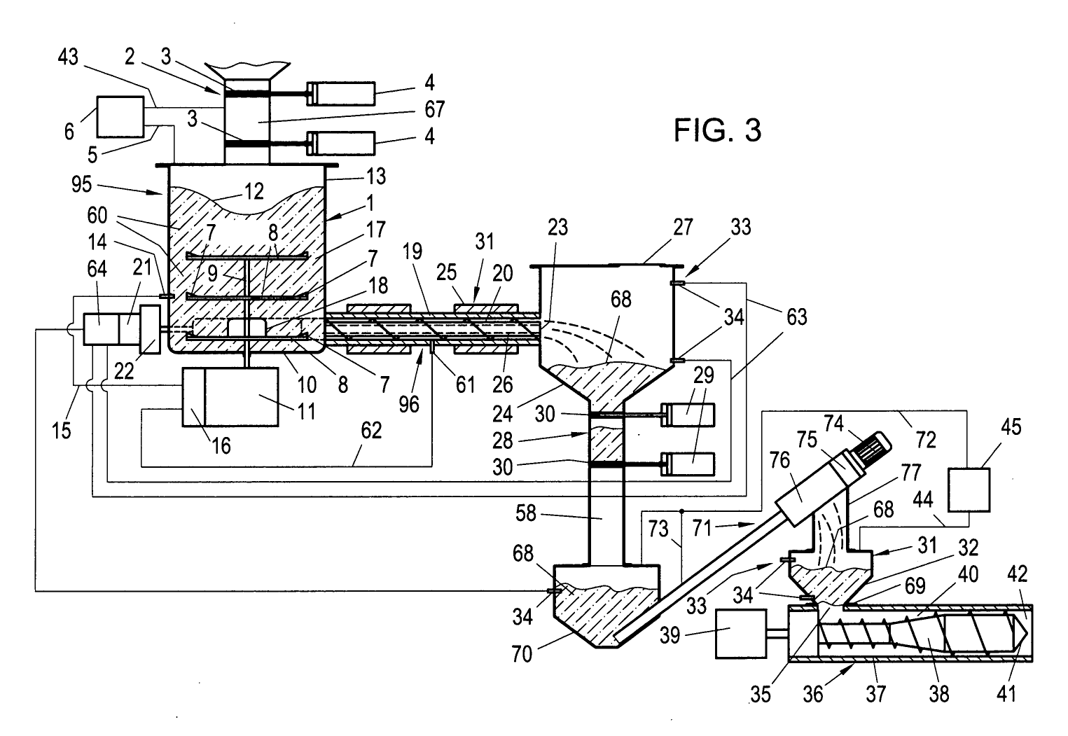

FIGS. 2 and 3 each show an embodiment variant of FIG. 1.

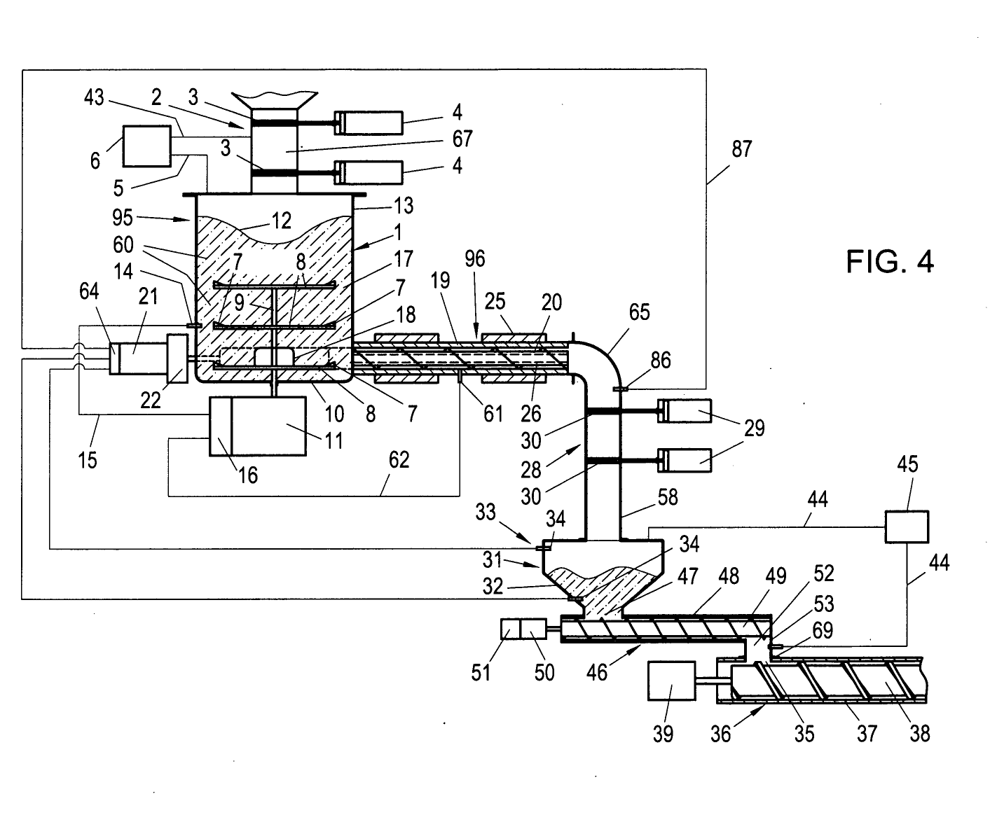

FIG. 4 shows an embodiment with a dosing means.

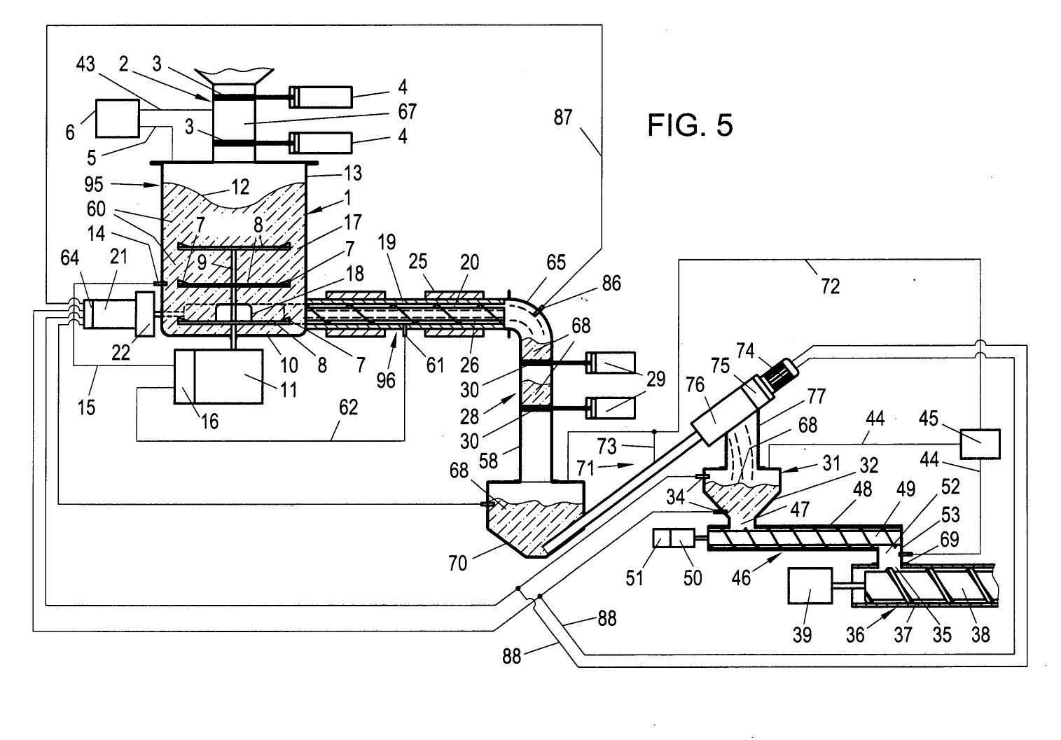

FIG. 5 is an embodiment variant of FIG. 4.

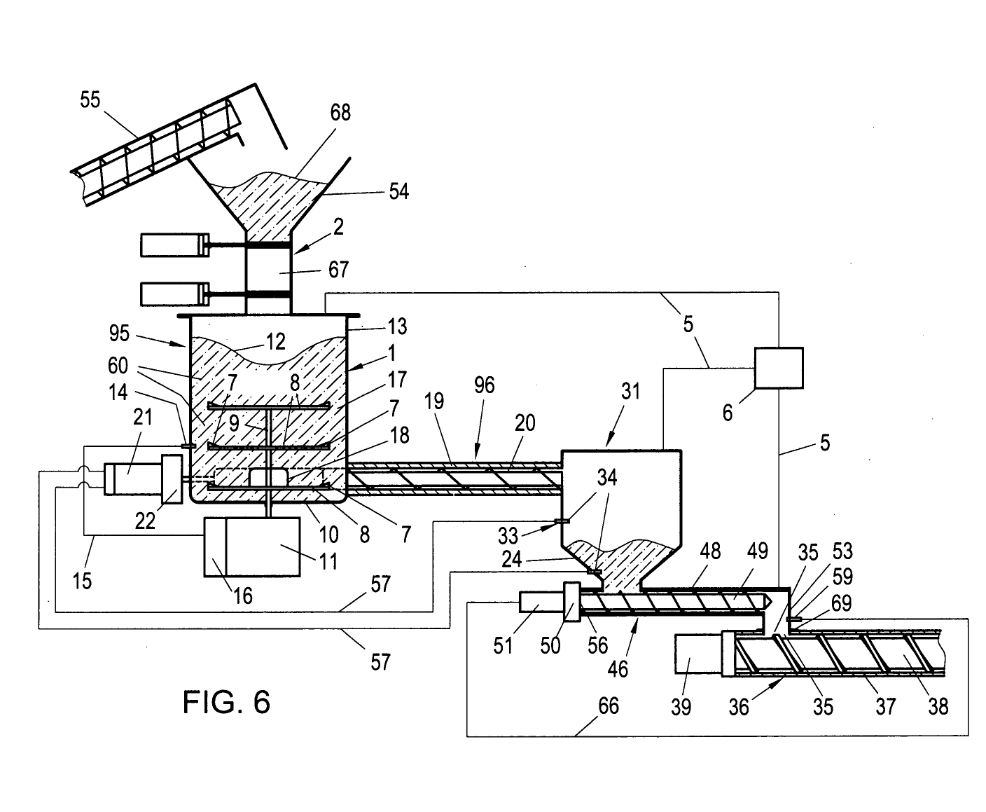

FIG. 6 shows a further embodiment with a dosing means.

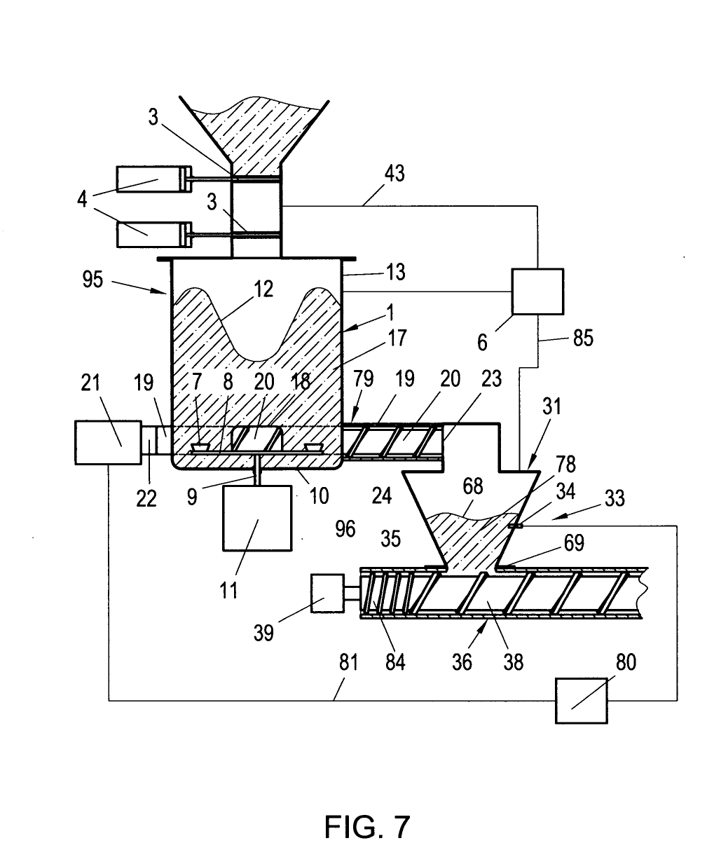

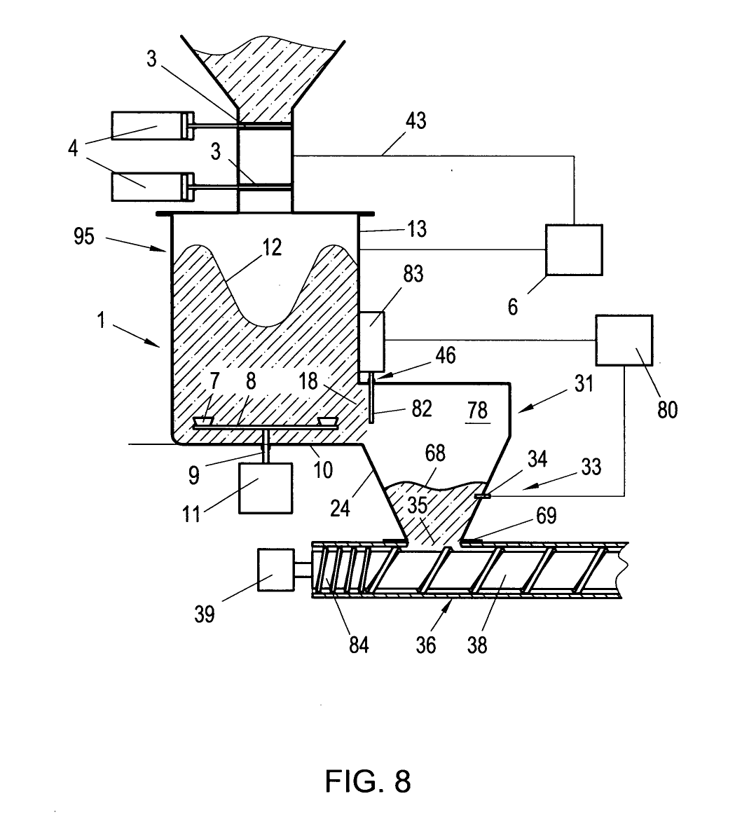

FIGS. 7 and 8 show further embodiments in which a transfer chamber is directly connected to the filling opening of the external extruder.

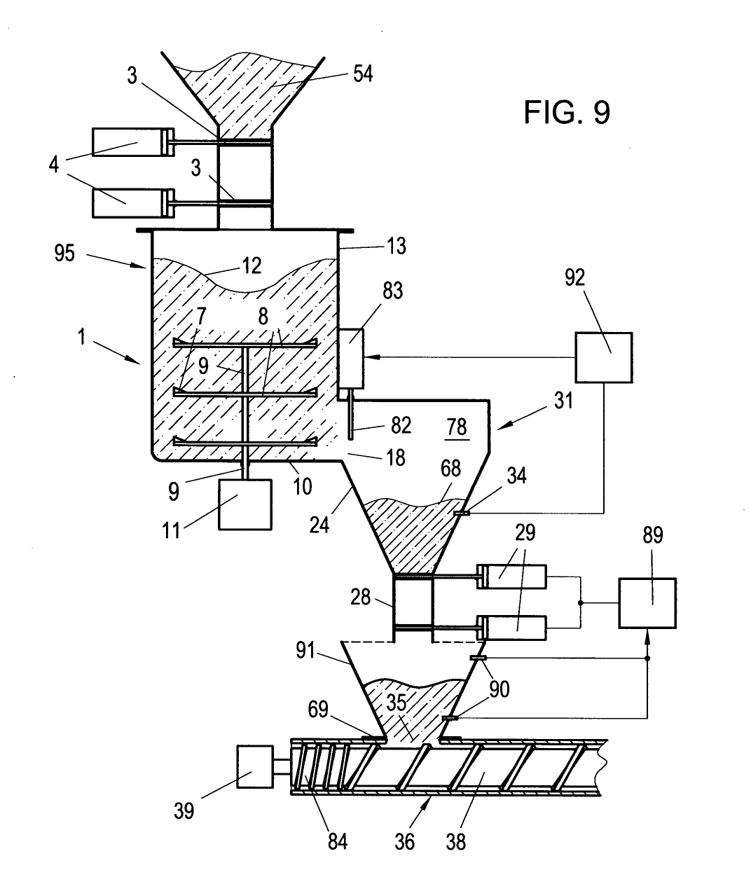

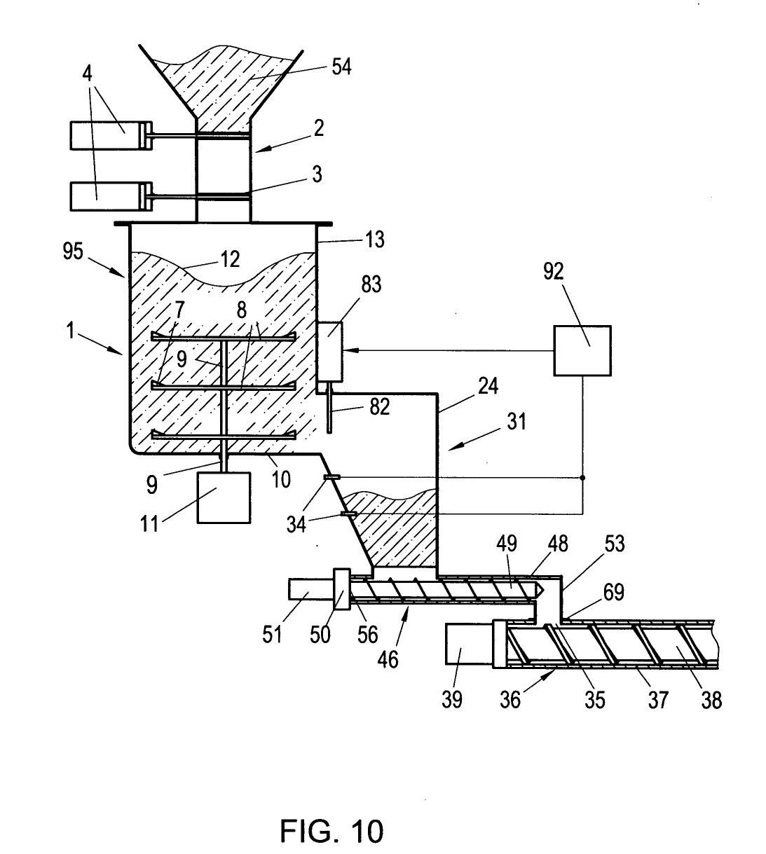

FIGS. 9 and 10 each shown an embodiment in which the discharge from the container is controlled by a valve formed by a slider.

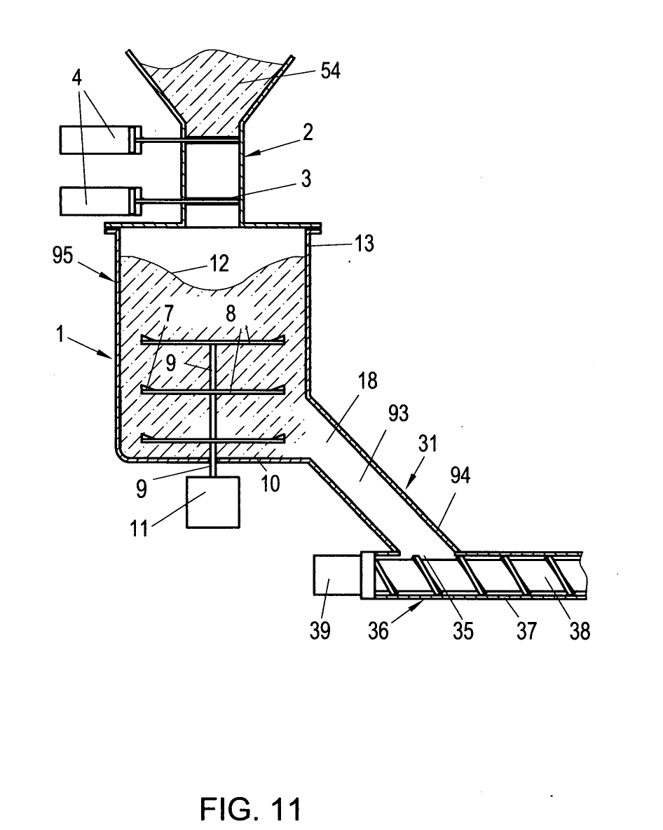

FIG. 11 shows a particularly simple embodiment.

In the embodiment according to FIG. 1, the thermoplastic plastics material to be processed, in particular PET (polyethylene terephthalate), is fed from above to a container 1, formed as a vacuum reactor, via a vacuum sluice 2, the upper and lower ends of which are sealable by a respective slider 3. The two sliders 3 are displaced between a closed position and an open position by hydraulically or pneumatically actuatable, double-acting cylinders 4. Instead of this type of sluice, a sluice formed as a rotor can also be provided, e.g. a cellular-wheel sluice, by means of which the container 1 can be continuously charged at least to some extent. The container 1 forms a single container stage 95, which does not, however, exclude the provision of a plurality of containers 1 operating in parallel in this container stage 95.

The container 1 is connected to a vacuum pump 6 by a vacuum line 5. In the container, tools 7 arranged one above the other rotate about the vertical container axis in a plurality of planes and are fixed to tool carriers, preferably carrier plates 8, which are arranged spaced apart one above the other and are mounted on a common vertical spindle 9 which preferably extends through the base 10 in a vacuum-tight bearing and is driven by a motor 11. By means of the rotation of the tools 7, the material, which is introduced into the container either continuously or in batches, is mixed and heated and optionally also comminuted if the tools 7 are correspondingly formed, e.g. with blades. This comminution is frequently unnecessary because the material 12 to be processed is already introduced into the container 1 in comminuted form, e.g. as granules or PET bottle chips. Although the aforementioned rotation movement of the tools 7 is to be produced in as structurally simple a manner as possible, a different type of movement of the tools 7 can also be provided for the aforementioned pretreatment of the material 12, e.g. an up and down movement of the tools 7, etc. The heating of the material in the container 1 is caused by the tools 7 and is monitored by sensors 14 connected by lines 15 to a control means 16 for controlling the speed of the motor 11. In this way, the material 12 processed in the container 1 can always be held at a desired temperature level so that the material is only heated, dried and, optionally, at least partly crystallised, but not plasticised. The temperature of the material in the container 1 therefore always lies below the melting or plasticising temperature of the processed material, thereby maintaining a flowable, non-sticky material state. The individual tool carrier plates 8 define, in the container 1, a plurality of treatment spaces 60 lying one above the other for the material 12 to be processed, which is introduced into the container 1 from above and, while being processed, gradually sinks downwards through the annular gaps 17 existing between the plates 8 and the container side wall 13 and into the region of the lowermost carrier plate 8. This ensures an adequate and narrowly defined residence time of the processed material in the container 1 and thus uniform processing of all the material fed in. The lowermost plate 8 is arranged in the vicinity of the container base 10, and its tools fling the processed material into a discharge opening 18 in the container side wall 13, which opening 18 lies at approximately the same height as this plate 8 and to which is connected a transfer section 31 which maintains the crystallised state of the material 12 and leads to the extruder 36. In the embodiment shown, this transfer section 31 first contains a delivery device 96 which assists the discharge of the material 12 from the container 1. This delivery device 96 has a screw housing 19, the feed opening of which is connected in a sealed manner to the opening 18. A screw 20 is rotatably mounted in the housing 19 and is formed as a simple feed screw, i.e. works compressionlessly so that the material that it picks up from the opening 18 is merely conveyed, but not or only very slightly plasticised, thereby maintaining the flowable state of the processed material. In the embodiment shown, the screw 20 is tangentially connected to the container 1 and, at is end lying on the left in FIG. 1, is driven by a motor 21 with a transmission 22. Instead of the tangential connection, a radial or oblique connection of the screw housing to the container wall can also be provided, optionally also a downwards connection. The screw feeds towards the right in FIG. 1, so that the crystallised material issuing at its delivery end 23 flows into a hopper 24 of the vacuum-tight transfer section 31. In order to keep the material conveyed by the screw 20 constantly at a desired temperature and flowable, the screw housing 19 can be provided with a temperature-control means 25, e.g. a heating device. Alternatively or additionally, a channel 26 for the passage of a temperature-control medium can be provided in the core of the screw 20. The temperature-control medium is fed into the channel 26 in a known manner via the output shaft of the transmission 22 by means of a rotary infeed. If necessary, in order to maintain the flowability of the material, the temperature of the material conveyed by the screw 20 can be monitored by means of at least one sensor 61, the signal from which is fed to the control means 16 via a line 62.

The state of the material 68 in the hopper 24, in particular its flowable state, can be monitored through an inspection glass 27. For monitoring the level in the hopper 24, a level control 33 is provided, the level probes 34 of which can be connected by lines 63 to a means 64 for controlling the speed of the motor 21 so that, in this way, the level in the hopper 24 can always be kept at a desired level. The material flows downwards from the hopper 24 into a vacuum sluice 28 which is closable in a vacuum-tight manner top and bottom by means of sliders 30 actuatable by cylinders 29 in a manner similar to that described for the sluice 2. Here too, a cellular-wheel sluice or the like can also be used. When the slider 30 is opened, the material in the vacuum sluice 28 falls downwards out of the outlet 58 thereof into a further hopper-like chamber 32 of the transfer section 31, which chamber 32 is also formed with a level control 33 with level probes 34. The signals from these level probes 34 can control the actuation of the lower slider 30 of the vacuum sluice 28. This is not shown in detail. The outlet of the chamber 32 is connected to the filling opening 35 of the extruder, which is formed by an external extruder 36, by means of a preferably air-tight coupling 69 formed in any manner, e.g. as a flanged joint. The feed region of the external extruder 36, adjacent to the filling opening 35, does not necessarily have to be vacuum-tight since the vacuum sluice 28, which is advantageously located in the transfer section 31 in the vicinity of the filling opening 35, ensures maintenance of the vacuum in the main region of the transfer section 31 between the container 1 and the vacuum sluice 28, and the region of the transfer section 31 lying between the vacuum sluice 28 and the filling opening 35 is only short, with the result that the material 12 only resides in this region for a short time, thereby avoiding substantial deterioration of the material. In the housing 37 of the external extruder 36 is arranged a screw 38, which is driven by a motor 39 and provided with a compression zone 40 so that the material conveyed by the screw 38 is plasticised and extruded in this state through at least one nozzle 41 of an extruder head 42 and supplied for further processing (e.g. granulation or injection into a mould).

The processed material is under vacuum from the vacuum sluice 2, the sluice chamber 67 of which can also be connected to the vacuum pump 6 by a vacuum line 43, as far as the outlet 58 of the vacuum sluice 28, thus avoiding any deterioration of the processed material 12 by the action of atmospheric oxygen and atmospheric moisture. In order to avoid such deterioration as much as possible also in the region between the vacuum sluice 28 and the extruder 36, the chamber 32 can be closed as tightly as possible and be provided with a supply line 44 for flushing with dry and preferably hot inert gas supplied from a gas source 45. Flushing with dry hot air may also be sufficient since complete air-tightness cannot be achieved if the external extruder is not gas-tight, which is frequently the case. However, the residence time of the material in the chamber 32 is short, with the result that the slight deterioration of the material is negligible in practice.

In order to make it easier to charge the screw 38 of the external extruder 36, the feed opening 35 is advantageously arranged in the top of the housing 37 of the external extruder 36 so that the supplied material automatically flows into the interior of the screw housing 37 under the effect of gravity. The material 68 in the chamber 32 forms a material pad in the chamber 32, which contributes towards uniform charging of the external extruder 36.

However, as FIG. 2 shows, the outlet 58 of the vacuum sluice 28 of the transfer section 31 can also be directly connected to the feed opening 35 of the extruder 36 by means of the coupling 69. This type of expenditure-reducing embodiment can be used if a particular method of charging the extruder 36 does not have to be taken into consideration, i.e. if its screw 38 can also be fully charged, which is carried out e.g. by opening the lower slider 30 if the vacuum sluice 28 is correspondingly filled.

In the two previously described embodiment variants, it was presupposed that the container 1 can be constructed in the vicinity of the extruder 36, which is formed in particular by an external extruder, so that the described connections are easily implementable. However, if there is insufficient space in the region of the external extruder for such a construction or if one wishes to arrange the container or containers 1 so as to be spatially separated from the external extruder 36, then a construction according to FIG. 3 can be used. It differs from the construction according to FIG. 1 principally in that the processed material 12 flows out of the outlet 58 of the vacuum sluice 28 and into a further chamber 70 forming a collecting vessel, from which the material is fed by a conveying means 71 to the desired point above the external extruder 36, advantageously to a point lying above the external extruder 36, so as to be able to convey the material 12 further under the effect of gravity. The conveying means 71 can e.g. be a screw mounted in a housing, or a pressure or suction conveyor. The conveying means 71 can be constructed so that a substantial ingress of air to the material 12 transported by it is avoided. For this purpose, the conveying means can be flooded e.g. with inert gas or, or if the material transported by it only resides in it for a short time, with hot dry air. In order to avoid the substantial ingress of air to the processed material, the chamber 70 is connected by a line 72 to the protective-gas source 45. This line 72 can also be used for the afore-mentioned process of flushing the conveying means 71 with protective gas. This is represented by the connecting line 73. The conveying means 71 advantageously extends into the base region of the chamber 70 in a sealed manner in order to be able to convey the material reliably from that point, even when the level in the chamber 70 is low. The level of the material 12 in the chamber 70 is monitored by a level probe 34, the signal from which is fed to the means 64 for controlling the speed of the motor 21.

The conveying means 71 is driven by a motor 74 and a transmission 75 and feeds the material via a transfer chamber 76 into a connecting piece 77, through which the material flows into the chamber 32 of the transfer section 31. From this point on, the construction corresponds to that according to FIG. 1.

In the embodiment according to FIG. 4, the vacuum sluice 28 is connected directly to the housing 19 of the feed screw 20 by a pipe bend 65, i.e. the hopper 24 shown in FIG. 1 has been omitted. In order to achieve dosability for charging the extruder 36, the plastics material, which is crystallised but not plasticised in the container 1 and which is conveyed by the screw 20 only in a flowable state, falls out of the outlet 58 of the vacuum sluice 28 and into the closed chamber 32 of the transfer section 31, in which a level control means 33 monitors the level by means of level sensors 34. The signals from the probes 34, which monitor the minimum and maximum levels in the chamber 32, are fed to the means 64 for controlling the speed of the motor 21 in order to regulate the volume conveyed by the screw 20 as a function of the level in the chamber 32. A further sensor 86 is provided in the region of the pipe bend 65; its signal is also fed to the control means 64 via the line 87. In this way, the pipe bend 65 is prevented from being overfilled with material.

The outlet opening of the hopper-like chamber 32 is fluidically connected to the feed opening 47 of a metering device or dosing means 46 formed by a feed screw 49 which is rotatably mounted in a housing 48 and driven by a motor 50. This motor is powered by a control means 51 which regulates the speed of the feed screw 49 and thus effects dosing, which can be weight- or volume-dependent. At the delivery end of the screw 49, the housing 48 of the feed screw 49 has, in its underside, an outlet opening 52, through which the flowably maintained plastics material falls into the feed opening 35 of the external extruder 36 via a connecting piece 53. The dosing means 46 permits highly uniform charging of the extruder 36, which is important in particular when the feed screw turns of the extruder 36 must not be completely filled, which is the case in particular for twin- or multi-screw extruders.

In order to prevent deterioration of the plastics material by the action of air along the path between the vacuum sluice 28 and the feed opening 35 of the extruder 36, both the sealed chamber 32 and the likewise sealed connecting piece 53 are connected to a gas source 45 by lines 44. A hot inert gas can be used for this purpose. However, flushing with hot dry air is also sufficient if deterioration of the material, which is low due to the short residence time, can be accepted.

The embodiment according to FIG. 5 differs from that according to FIG. 4 in that, in a manner similar to that described for the embodiment according to FIG. 3, a conveying means 71 is provided in the transfer section 31 and bridges the spatial distance between the container 1 and the vacuum sluice 28 connected thereto and the dosing means 46 connected to the external extruder 36. The construction and the drive of this conveying means 71 can correspond to the construction described in connection with FIG. 3. The signals from the level probes 34 can control not only the motor 21, but also the motor 74 of the conveying means 71 via lines 88.

A further essential difference between the embodiments according to FIGS. 1, 2 and 3 on the one hand and those according to FIGS. 4 and 5 on the other hand is that, in the first-mentioned embodiments, the hopper 24 and the sluice 28 effect predosing in the transfer section 31 and are vacuum-tight. In contrast, in the embodiments according to FIGS. 4 and 5, the dosing means, which is substantially formed by the chamber 32 and the screw 49, does not necessarily have to be under vacuum, but it is advantageous at least to flush the chamber 32 with dry air or protective gas in order to protect the treated material.

In the embodiment according to FIG. 6, the container 1 is filled by a conveying means 55 via the vacuum sluice 2 and a filling hopper 54. A conveyor belt or a feed screw can be used for this purpose. The vacuum sluice 28 in FIGS. 1 to 5 has been omitted, with the result that the installation is under vacuum from the container 1 as far as the interior of the housing 37 of the external extruder 36, which presupposes that the feed region of the external extruder 36 is vacuum-tight or can be brought into this state during assembly of the device. For this purpose, it is usually only necessary to form the motor-side seal 56 of the housing 37 of the external extruder 36 in a vacuum-tight manner. Measures suitable for this are known and do not require further explanation here.

In this embodiment, the feed screw 20 conveys the material, in a manner similar to that described for the embodiment according to FIG. 1, into a hopper 24 of the transfer section 31, the hopper 24 being provided with a level control 33, the level probes 34 of which sense the level in the hopper 24. This effects dosing in that the signal supplied by the probes 34 is fed via lines 57 to the control means 21 which regulates the speed of the drive motor 22 of the feed screw 20. The motor-side seal 56 of the housing 48 of the screw 49 must be vacuum-tight. The screw 49 conveys the flowably maintained plastics material, preferably controlled by weight or by volume, into the connecting piece 53, whence it falls downwards into the filling opening 35 of the housing 37 of the extruder 36. It is also advantageous to monitor the maximum level in the connecting piece 53 by means of a probe 59 in order to prevent overfilling of the connecting piece 53. The signal from this probe 59 can e.g. influence the control means 51 via a line 66.

Although the vacuum generated in the container 1 by the vacuum pump 6 would continue into the transfer hopper 24 via the housing 19 of the screw 20 and from there into the extruder 36 via the housing 48 of the feed screw 49, it is more advantageous if the transfer hopper 24 and the connecting piece 53 are also evacuated via lines 5. Separate vacuum sources 6 can optionally be provided for this purpose, but for economical reasons a common vacuum source 6 is likely to be used.

A conveying means 71, as shown in FIGS. 3 and 5, can also be used in the embodiment according to FIG. 6 in order to be able to arrange the container 1 with spatial separation from the external extruder 36. In FIG. 6, this conveying means would advantageously be interposed between the hopper 24 and the dosing means 46. Its construction can correspond to the previously described construction, although in a vacuum-tight configuration.

In the embodiment according to FIGS. 7 and 8, the outlet opening of a hopper 24 of the transfer section 31 is directly connected in a sealed manner to the filling opening 35 of the external extruder 36 by means of the coupling 69, the hopper 24 surrounding a transfer chamber 78. The previously described vacuum sluice 28 has been omitted here. According to FIG. 7, the hopper 24 is filled by a conveying means 79 formed here as a compressionless screw 20 which is connected to the container 1 in a manner similar to that shown in FIG. 1. The level of the material falling into the transfer chamber 78 at the delivery end 23 of the screw 20 is monitored in the transfer chamber 78 by a level control 33 comprising at least one level probe 34 for this level. The level signal thus obtained is evaluated by a control means 80 which is connected by a line 81 to the motor 21 of the feed screw 20. In this way, the level control 33 regulates the speed of the screw 20 in such a way that a predetermined, desired level of the material 68 is always maintained in the transfer chamber 78.

According to FIG. 8, the transfer chamber 78 formed by the hopper 24 is directly connected to the discharge opening 18 of the container 1, i.e. the conveying means 79 has been omitted. Instead, the dosing means 46 is arranged between the container 1 and the transfer chamber 78 and is formed here by a valve 82, e.g. a sliding valve. Its slider is moved by a pneumatic or hydraulic unit 83 which is controlled by the control means 80 of the level control 33. This is carried out so that the desired level of the material 68 is always maintained in the hopper 24. In this case, the transfer chamber 78 is filled by the material, which is set into rotation in the container 1 by the tools 7, being flung into the discharge opening 18 of the container 1 by centrifugal action or, if the tools 7 are formed accordingly, also by a spatula effect. The slider of the valve 82, which is shown in the half-open position, can be set so that the transfer chamber 78 is continuously charged with flowable material from the container 1, i.e. without interruption. Instead, the transfer chamber 78 can also be charged batchwise if the slider of the valve 82 is only intermittently opened from its closed position.

As the treated material only resides in the transfer chamber 78 for a relatively short time, additional evacuation of the transfer chamber 78 or flushing with protective gas is not absolutely necessary here, in particular if the hopper 24 surrounding the transfer chamber 78 is sealed and if the feed region of the external extruder 36 is at least substantially vacuum-tight. If this is not the case, the previously described measures can be used. For example, it is shown in FIG. 7 that the hopper 27 is connected to the vacuum pump 6 by a line 85.

In FIGS. 7 and 8, only a single carrier plate 8 with tools 7 is shown for reasons of simplicity. However, it is preferable if embodiments according to FIGS. 7 and 8 are also formed with a plurality of carrier plates 8 or other tool carriers.

In FIGS. 7 and 8, the motor-side end of the screw 38 of the external extruder 36 is provided in a manner known per se with a sealing thread 84, the feed direction of which is the same as that of the screw 38. However, the pitch and depth of the sealing thread 84 are smaller than those of the screw 38. This type of sealing thread can, of course, also be used in the other embodiments.

In the embodiment according to FIG. 9, a valve 82 provided with a slider regulates the discharge of the material 12 from the container 1 in a manner similar to that described in FIG. 8. The material flung out of the container 1 by the tools 7 is collected in the hopper 24. The level in the hopper 24 is monitored by means of the level probe 34, which controls the sliding valve 82 in a manner similar to that described for FIG. 8. A vacuum sluice 28 is connected to the outlet end of the hopper 24. Its two sliders are actuated by means of cylinders 29 connected to a control means 89, to which are fed the signals from two level probes 90 monitoring the level in a further hopper 91 which is arranged downstream of the vacuum sluice 28 and is connected by means of the coupling 69 to the filling opening 35 of the extruder 36. In this embodiment, the hopper 91 does not necessarily have to be vacuum-tight, which is indicated by the broken line representing its wall. The resulting low deterioration of the material can be accepted as the material only resides in the hopper 91 for a very short time.

The embodiment according to FIG. 10 is similar to that according to FIG. 6, but in FIG. 10 the valve 82 controlling the discharge from the container 1 takes the place of the feed screw 20. The two probes 34 monitoring the level in the hopper 24 deliver their signals 4 to a control means 92 which controls the unit 83 of the valve 82 in a manner similar to that shown in FIG. 9.

The embodiment according to FIG. 11 is structurally particularly simple: the transfer section 31 is simply formed by a channel 93 defined by a pipe 94 which directly connects the discharge opening 18 of the container 1 to the filling opening 35 of the extruder 36 in a sealed manner. The material processed in the container 1 is discharged by the centrifugal effect of the tools 7. The flowability of the material ensures that the material in the pipe 94, which is inclined towards the extruder 36, passes reliably to the filling opening 35. In this embodiment, the feed region of the extruder 36 and the transfer section 31 have to be gas-tight, since otherwise the vacuum in the container 1 is disrupted.

In all embodiments, the processed plastics material, in particular PET, is not melted or plasticised until it is in the extruder 36. This can be a single-screw extruder or a multi-screw extruder and can be constructed with or without degassing.

In particular if the extruder 36 is a multi-screw extruder, the variants with a dosing means 46 are used. This has procedural advantages. Namely, twin screws also plasticise well when they are only partly filled (underfed), and regulating the throughput to provide a constant throughput is possible simply by means of the regulation carried out by the dosing means. As partly filled screw turns allow atmospheric oxygen to act greatly upon the plasticised hot plastics, evacuating the dosing means 46 and the external extruder 36 or flushing them with inert gas is preferable over flushing with dry air for these applications.

1. A device for filling an extruder (36) with pretreated thermoplastic plastics material, in particular PET, comprising at least one evacuatable container (1) in which moving, in particular rotating, tools (7) are provided for pretreatment of the material, wherein the pretreatment comprises drying and, optionally, crystallisation or partial crystallisation of the material, and wherein each container (1) has a discharge opening (18) for the preferably at least partly crystallised material, which discharge opening (18), with respect to the material, is fluidically connected to the filling opening (35) of the extruder (36), characterised in that a transfer section (31), which maintains the flowable state of the material pretreated in the containers (1), is connected to the outlet opening (18) of the containers (1) so as to form a sealed fluidic connection for the material, the containers (1) optionally forming a plurality of container stages, and in that this transfer section (31) has, at its outlet, a coupling (69) which is directly connectable in a sealed manner to the filling opening (35) of the extruder (36).

2. A device according to claim 1, characterised in that the device itself is extruderless and is connectable by means of the coupling (69) to the filling opening (35) of the extruder, which is formed by an external extruder (36).

3. A device according to claim 2, characterised in that the transfer section (31) is evacuatable for connection to the filling opening (35) of the external extruder (36), the feed region of which is vacuum-tight.

4. A device according to claim 1, characterised in that, in particular for connection to the filling opening (35) of an external extruder (36) which does not have a vacuum-tight feed region, the transfer section (31) contains a vacuum sluice (28) which is preferably arranged in the transfer section (31) in the vicinity of the filling opening (35) or in the vicinity of the coupling (69).

5. A device according to claim 1, characterised in that the transfer section (31) has at least one hopper (24, 91) or hopper-like collecting chamber, into which the material (12) flows and the outlet opening of which is fluidically connected to the outlet of the transfer section (31), said outlet having the coupling (69).

6. A device according to claim 1, characterised in that the transfer section (31) has a delivery device (96) connected to the discharge opening (18) of the container (1).

7. A device according to claim 6, characterised in that the delivery device (96) has a compressionless screw (20) or a cellular-wheel conveyor.

8. A device according to claim 6, characterised in that a means (64) is provided for regulating the feed volume or feed weight of the delivery device (96).

9. A device according to claim 1, characterised in that a valve (82), in particular a slider, which regulates the discharge of the material (12) from the container (1), is provided between the discharge opening (18) of the container (1) and the transfer section (31).

10. A device according to claim 1, characterised in that, for connection of the device to a twin- or multi-screw extruder, the transfer section (31) has a metering device (46) for filling this extruder (36).

11. A device according to claim 10, characterised in that the metering device (46) has at least one conveying means which transports the material towards the extruder (36) and the feed volume or feed weight of which is controlled in dependence upon the filling requirement of the extruder (36).

12. A device according to claim 1, characterised in that the transfer section (31) has at least one transfer chamber (32, 76) provided with a level control (33).

13. A device according to claim 1, characterised in that the transfer section (31) has at least one conveying means (71) for the flowable material, e.g. a feed screw, which conveying means (71) bridges at least a large part of a spatial distance between the container (1) and the extruder (36).

14. A device according to claim 1, characterised in that the entire transfer section (31) is sealed in relation to the ambient air and is evacuatable.

15. A device according to claim 1, characterised in that the transfer section (31) has at least one unevacuated region which is preferably flushed with a gaseous medium, e.g. inert gas, dry air or hot air, which protects the material in this region.

16. A device according to claim 1, characterised in that the transfer section (31) is formed by a channel (93) which connects the discharge opening (18) of the container (1) directly to the coupling (69).

17. A device according to claim 1, characterised in that the container (1) has a plurality of treatment spaces (60) defined by carrier plates (8), arranged one above the other, for the rotating tools (7).

18. A device according to claim 1, characterised in that at least one sensor (14) for monitoring the temperature of the material (12) treated in the container (1) is provided for each container (1) in or on the container (1).

19. A device according to claim 1, characterised in that a means (64) is provided for regulating the movement of the tools (7), in particular the speed of rotating tools (7).

20. A device according to claim 1, characterised in that a channel (26) for the passage of a temperature-control medium is provided in the core of the screw (20).

21. A device according to claim 1, characterised in that only a single container stage (95) with preferably only a single container (1) is provided.

22. A device for filling an extruder with pretreated thermoplastic plastics material comprising at least one evacuatable container having moving tools for pretreating the material by drying and at least partially crystallizing the material and a discharge opening for the at least partly crystallized, flowable material which, with respect to the material, is fluidly connected to a filling opening of the extruder; a transfer section for the flowable material pretreated in the containers sealingly connected to the discharge opening and forming a fluid connection for the material, the transfer section having an outlet; a coupling for directly and sealingly connecting the outlet to the filling opening of the extruder, the transfer section including a metering device for filling the extruder and a level control unit, and wherein the level control unit controls at least one of the metering device and a volume of the material transported by the metering device as a function of the degree to which the extruder is filled with the material.
